(19) United States
(12) Patent Application Publication
(10) Pub. No.: US 2021/0221686 A1
(43) Pub. Date: Jul. 22, 2021

(54) METHOD FOR CHEMICALLY EXFOLIATING GRAPHITE

(71) Applicant: NITTO DENKO CORPORATION, Osaka (JP)

(72) Inventor: Shijun Zheng, San Diego, CA (US)

(21) Appl. No.: 16/760,589

(22) PCT Filed: Oct. 31, 2018
(86) PCT No.: PCT/US2018/058376

§ 371 Date: Apr. 30, 2020

Related U.S. Application Data
(60) Provisional application No. 62/579,773, filed on Oct. 31, 2017.

(51) Int. Cl. C01B 32/198

(52) U.S. Cl. CPC C01B 32/198; C01P 2004/61

(57) ABSTRACT

Described herein is a method for producing dispersions of graphene oxide in aqueous solution wherein the size of the graphene oxide flakes, planes, sheets or platelets is larger than 5 μm.

### CROSS-REFERENCE TO RELATED APPLICATIONS

This application claims the benefit of U.S. Provisional Application Ser. No. 62/579,773, filed Oct. 31, 2017, which is incorporated by reference herein in its entirety.

### BACKGROUND

### Field

The present disclosure is related to methods for exfoliating and/or delaminating graphene oxide sheets.

### Description of Related Art

Graphene, a miracle material, has a structure of one-atom-thick planar sheets of carbon atoms. Despite the rather short research period as compared to those for other nanocarbon materials such as carbon nanotube (CNT), fullerene or graphite, graphene is highly valued because of its excellent thermal conductivity and electron mobility and peculiar advantages such as flexibility.

Graphene oxide, or GO, is an oxidized version of graphene and is produced from readily available graphite via oxidation. Graphene oxide is dispersible in water and, due to the abundance of oxygen atoms on its surface, may be readily augmented with a variety of functional groups. The variety of functionalization allows for manipulation of the properties of graphene oxide and makes it an interesting substrate for membranes, films and coatings with applications to a variety of industries. There are many published methods for the preparation of graphene oxide. However, the known methods may not provide the desired sized platelets, flakes, sheets or planes of graphene oxide for a given application. Accordingly, there is a need of a simple method for preparing exfoliated graphene oxide in a variety of sizes.

### SUMMARY

This disclosure relates to a method for exfoliating graphene oxide to provide larger sized graphene platelets, flakes, sheets or planes.

Some embodiments include a method for preparing graphene oxide. In some embodiments, the method can comprise washing a crude graphene oxide solid with a dilute acidic solution, redispersing the solid into an aqueous solution, and/or mildly sonicating the redispersed mixture.

Some embodiments include a method for preparing graphene oxide (GO), comprising optionally mildly sonicating a dispersion of treated GO in an aqueous solution, wherein the treated GO has been treated by a method comprising washing a crude GO solid with dilute acid solution and water then isolating the treated GO by filtering prior to dispersing the treated GO in the aqueous solution.

These and other embodiments are described in greater detail below.

### BRIEF DESCRIPTION OF THE DRAWINGS

FIG. 1 is a diagram showing the dimensions of a graphene platelet.

### DETAILED DESCRIPTION

Emerging graphene materials have many attractive properties, such as a 2-dimensional sheet-like structure with extraordinary high mechanical strength and nanometer scale thickness. Graphene oxide (GO), an exfoliated and oxidized form of graphite, can be mass produced at low cost. With its high degree of oxidation, GO has high water permeability and also exhibits versatility in that it may be modified by including many functional groups, such as amines or alcohols, to form various membrane structures. Unlike traditional membranes, where the water is transported through the pores of the material, in graphene oxide membranes the transportation of water can be between the interlayer spaces. Graphene oxide's capillary effect can result in long water slip lengths that offer fast water transportation rate. Additionally, the membrane's selectivity and water flux can be tuned by manipulating the interlayer distance of graphene sheets.

With respect to the present method, the filtered crude graphene oxide solid can be produced by any suitable method. In some embodiments, the crude graphene oxide solid is produced by the Staudenmeier-Hoffman-Hamdi method or a modification thereof: Ojha, Kasinath; Anjaneyulu, Oruganti; Ganguli, Ashok (10 Aug. 2014). “Graphene-based hybrid materials: synthetic approaches and properties”. Current Science. 107 (3): 397-418. In some embodiments the crude graphene oxide solid can include preparing GO from graphite using modified Hummers' method: Hummers, William S.; Offeman, Richard E. (Mar. 20, 1958). “Preparation of Graphitic Oxide”. Journal of the American Chemical Society. 80 (6): 1339. Graphite flake (4.0 g, Aldrich, 100 mesh) can be oxidized in a mixture of sodium nitrate, potassium permanganate and concentrated sulfuric acid. The Hummers' method can also be modified: Kovtyukhova, N. I.; Ollivier, P. J.; Martin, B. R.; Mallouk, T. E.; Chizhik, S. A.; Buzaneva, E. V.; Gorchinskiy, A. D. (March 1999). “Layer-by-Layer Assembly of Ultrathin Composite Films from Micron-Size Graphite Oxide Sheets and Polycations”. Chemistry of Materials. 11: 771-778. Chen, Ji; Yao, Bowen; Li, Chun; Shi, Gaoquan (November 2013). “An improved Hummers' method for eco-friendly synthesis of graphene oxide”. Carbon. 64: 225-229. The oxidizing agents can be mixed at an elevated temperature for a sufficient period of time to effect oxidation of the graphite to graphene oxide. Suitable time and heat for providing sufficient oxidation by the above described oxidizing agents can be at room temperature to about 100° C., e.g., 50° C., for a time sufficient to effect oxidation of the graphite, e.g., for 15 hours. The resulting oxidized graphite can be poured into ice to absorb the heat generated from mixing concentrated sulfuric acid with water in performing the modified Hummers' methodology. In some embodiments, an additional oxidizing agent can be added to the oxidized graphite/graphene oxide, e.g., hydrogen peroxide. A suitable amount of hydrogen peroxide can be enough to be stoichiometrically in excess to fully reduce MnO₂, e.g., about 40 ml of 30% hydrogen peroxide. The resulting suspension can be stirred for a sufficient time to reduce manganese dioxide, e.g., about 2 hours. In some embodiments, the reduced suspension can then be filtered through filter paper to remove the solid manganese dioxide and/or provide a filtered crude graphene oxide solid.

Some methods include washing the crude graphene oxide with a dilute acid solution. It is believed that the dilute acidic solution may reduce the amount of GO platelet gelation. Any type of acid, such as a strong or weak acid, may be used in the dilute acid solution. In some embodiments the dilute acid solution comprises a strong acid with pH less than 5, such as about 0-1, about 1-2, about 2-3, about 3-4, about 4-5, about 0-2, about 2-4, or about 3-5. In some embodiments, the dilute acid solution is a mineral acid, such as hydrochloric acid, sulfuric acid, phosphoric acid, nitric acid, or a mixture thereof. In some embodiments, the dilute acidic solution comprises hydrochloric acid. Weak acids, such as acetic acid, citric acid, etc., may also be used.

Any suitable concentration of the dilute acid, e.g. dilute HCl, may be used to wash the crude graphene oxide, e.g. be about 0.01-0.02 N, about 0.02-0.03 N, about 0.03-0.04 N, about 0.04-0.05 N, about 0.05-0.06 N, about 0.06-0.07 N, about 0.07-0.08 N, about 0.08-0.09 N, about 0.09-0.1 N, about 0.1-0.11 N, about 0.11-0.12 N, about 0.12-0.13 N, about 0.13-0.14 N, about 0.14-0.15 N, about 0.15-0.16 N, about 0.16-0.17 N, about 0.17-0.18 N, about 0.18-0.19 N, about 0.19-0.2 N, about 0.2-0.21 N, about 0.21-0.22 N, about 0.22-0.23 N, about 0.23-0.24 N, about 0.24-0.25 N, about 0.25-0.26 N, about 0.26-0.27 N, about 0.27-0.28 N, about 0.28-0.29 N, about 0.29-0.3 N, about 0.3-0.31 N, about 0.31-0.32 N, about 0.32-0.33 N, about 0.33-0.34 N, about 0.34-0.35 N, about 0.35-0.36 N, about 0.36-0.37 N, about 0.37-0.38 N, about 0.38-0.39 N, about 0.39-0.4 N, about 0.4-0.41 N, about 0.41-0.42 N, about 0.42-0.43 N, about 0.43-0.44 N, about 0.44-0.45 N, about 0.45-0.46 N, about 0.46-0.47 N, about 0.47-0.48 N, about 0.48-0.49 N, about 0.49-0.5 N, about 0.01-0.1 N, about 0.1-0.2 N, about 0.2-0.3 N, about 0.3-0.4 N, about 0.4-0.5 N, about 0.1-0.2 N, about 0.15-0.25 N, about 0.12-0.16 N, about 0.01-0.5N, or any concentration in a range bounded by any of these values. Ranges formed by combination of any of the ranges above may be of particular interest when they encompass, or are near, the following values for concentration: about 0.16 N, about 0.07 N, or about 0.3 N are of particular interest.

Any suitable volume of the dilute acid could be used. In some embodiments, the volume of dilute acid solution can be about one bed volume, e.g., about 250 mL to 1 L. In some embodiments, the volume of dilute acid solution can be about 10-100 mL, about 100-500 mL, about 250-750 mL, about 500 mL to about 1 L, about 750 mL to about 1 L, about 1-1.5 L, about 1.5-2 L, about 2-5 L, about 5-10 L, about 10-25 L, or any volume bounded by, or between, any of these ranges.

Any suitable amount of crude GO may be washed with a dilute acid solution. For example, the amount of the crude graphene oxide washed with the dilute acid solution may be about 100 mg to about 200 mg, about 100-500 mg, about 500 mg to about 1 g, about 1-5 g, about 5-10 g, about 10-20 g, about 20-50 g, about 50-100 g, about 100-500 g, about 500 g to about 1 kg, about 1-10 g, about 2-10 g, about 4-5 g, about 5-15 g, about 10-15 g, about 15-30 g, about 25-50 g, about 75-125 g, about 250-400 g, or any amount bounded by, or between, any of these ranges.

The crude GO may be washed with the dilute acid by any suitable means. For example, in some embodiments, the crude GO may be washed by pouring the dilute acid solution over GO that is supported on a piece of filter paper in a filtration apparatus. In some embodiments, the crude GO is added to the dilute acid solution and stirred. The stirring may occur for about 1 min to about 1 h, about 1-2 h, about 2-3 h, about 4-24 h, about 6-12 h, about 15-18 h, or any about of time bounded by, or between, any of these ranges. The rate of stirring may be 5-500 rpm, 5-10 rpm, 10-50 rpm, 50-100 rpm, 100-200 rpm, 200-500 rpm, or any range bounded by, or between, any of these ranges. After completion of stirring the acid washed GO is isolated by filtration.

Optionally, the acid washed GO may be further washed with water or aqueous solution, such as deionized (DI) water, distilled water, or filtered water. The volume of water or aqueous solution used can be about one bed volume, e.g., about 250 mL to 1 L. In some embodiments, the amount of water or aqueous solution can be 100-500 mL, about 250-750 mL, about 500 mL to 1 L, about 750 mL to about 1 L, about 1-1.5 L, about 1.5-2 L, about 2-5 L, about 5-10 L, about 10-25 L, or any volume bounded by, or between, any of these ranges.

The water washing (or washing with an aqueous solution) may occur by pouring the water directly onto and through the acid washed GO supported on a piece of filter paper in a filtration apparatus. In another embodiment the acid washed GO may be added to the water or aqueous solution and stirred. The stirring may occur for about 1 min to about 1 h, about 1-2 h, about 2-3 h, about 4-24 h, about 6-12 h, about 15-18 h, or any about of time in a range bounded by, or between, any of these values. The rate of stirring may be about 5-500 rpm, about 5-10 rpm, about 10-50 rpm, about 50-100 rpm, about 100-200 rpm, about 200-500 rpm, or any rate bounded by, or between, any of these values. After completion of stirring, the washed GO may be isolated by filtration. In some embodiments the water wash can be repeated one or more times.

Water washing may be carried out 1, 2, 3, 4, or more times. In some embodiments, the GO is washed twice after being washed with dilute acid.

The solid GO thus obtained is then added to water or an aqueous solution. In some embodiments, the solid GO is added to DI water. The volume of water or aqueous solution used can be about 100 mL to 100 L, about 100-500 mL, about 250-750 mL, about 500 mL to 1 L, about 750 mL to about 1 L, about 1-1.5 L, about 1.5-2 L, about 2-3 L, about 3-4 L, about 4-5 L, about 2-5 L, about 5-10 L, about 10-25 L about 200 L, or any volume in a range bounded by any of these values.

In some embodiments, the solid GO can be dispersed in the water or aqueous solution by stirring the GO into a sufficient amount of aqueous solution obtain the desired concentration such as about 0.1-10 g/L, about 0.1-1 g/L, about 0.5-1 g/L, about 1-2 g/L, about 2-5 g/L, about 3-8 g/L, about 4-10 g/L, or any concentration in a range bounded by any of these values.

The GO may be stirred in the water or the aqueous solution for any suitable period of time, such as at least about 12 hours, at least about 24 hours, at least about 36 hours, at least about 48 hours, about 1-10 min, about 5-15 min, about 15-30 min, about 30-60 min, about 1-2 h, about 2-6 h, about 6-12 h, about 12-24 h, about 1-2 days, about 2-3 days, about 3-4 days, about 4-5 days, about 2-5 days, or any time period in a range bounded by any of these values.

The GO may be stirred in the water or the aqueous solution at any suitable rate, such as about 5-500 rpm, about 5-10 rpm, about 10-50 rpm, about 50-100 rpm, about 100-200 rpm, about 200-500 rpm, or any rate bounded by, or between, any of these values.

GO which is dispersed in water or an aqueous solution, and optionally subjected to any of, any combination of, or all of the other treatment steps identified above, may optionally be mildly sonicated for a period of time. In some embodiments, the dispersion is cooled in an ice-water bath during sonication, which may potentially reduce graphene oxide fragmentation. One way to measure or quantify the power of the sonication is measured in watts per gram. For example, 10 watts applied to 2 L (2000 g) of dispersion solution, would be 10 watts/2000 g, which equals 0.005 watts/g. In some cases the sonication power is about 0.0001-0.0005 watts/g, about 0.0005-0.001 watts/g, about 0.0005-0.01 watts/g, about 0.001-0.005 watts/g, about 0.005-0.01 watts/g, about 0.01-0.05 watts/g, about 0.05-0.1 watts/g, about 0.001-0.1 watts/g, 0.001-0.01 watts/g, about 0.1 watt/g, about 0.005 watt/g, or any sonication power in a range bounded by any of these values. The time period of mild sonication can be about 1-2 min, about 1-5 min, about 1-10 min, about 5-10 min, about 5-15 min, about 10-20 min, about 15-30 min, about 20-40 min, about 30-60 min, about 45 min to 1 h, about 1-2 h, about 2-4 h, about 3-6 h, about 6-12 h, about 12-24 h, about 1-2 days, about 2-5 days, about 1 min to about 100 hours, or about any time period in a range bounded by any of these values.

After the optional mild sonication, the GO dispersion may be centrifuged to remove large non-exfoliated graphene or graphene oxide. This may help to remove multilayered graphene oxide sheets, such as graphene oxide sheets having more than 5 layers. In some embodiments, the centrifugation is conducted at a speed of about 500-1000 rpm, about 1000-2000 rpm, about 2000-3000 rpm, about 3000-4000 rpm, about 4000-5000 rpm, about 1000-3000 rpm, about 3000-5000 rpm, about 3000 rpm, about 1000-5000 rpm, about 2000-4000 rpm, or any other speed in a range bounded by any of these values.

The GO dispersion may be centrifuged for any suitable period of time, such as about 1-5 min, about 1-10 min, about 5-10 min, about 10-20 min, about 15-20 min, about 20-40 min, about 30-40 min, about 30-60 min, about 40-60 min, about 10-60 min, about 1 min to 100 hours, about 2 h, at least about 10 min, at least about 20 min, at least about 30 min, at least about 40 min, at least about 60 min, or any time period in a range bounded by any of these values. In some embodiments, the centrifuged dispersion is isolated by decanting the aqueous liquid containing GO having the desired particle size from the larger graphene or graphene oxide particles.

The methods described herein may be useful to obtain graphene oxide having a larger platelet size, such as greater than about 5 microns (or micrometers, μm), greater than about 10 μm, greater than about 20 μm, greater than about 25 μm, greater than about 30 μm, greater than about 40 μm, or greater than about 50 μm, about 0.5-100 μm, about 5-20 μm, about 20-30 μm, about 30-40 μm, about 40-50 μm, about 50-60 μm, about 60-70 μm, about 70-80 μm, about 80-90 μm, about 90-100 μm, about 100-500 μm, about 40-60 μm, about 10-50 μm, about 25-50 μm, about 5-50 μm, about 30-50 μm, about 20-60 μm, or about 50 μm.

In some embodiments, the GO dispersion is centrifuged in a manner that is equivalent to centrifuging at about 3000 rpm for about 40 minutes.

In some embodiments, the optionally substituted graphene oxide may be in the form of sheets, planes or flakes. In some embodiments, the graphene oxide material may have a surface area of about 100-5000 m²/gm, 100-500 m²/gm, about 500-1,000 m²/gm, about 1,000-2,000 m²/gm, about 2,000-3,000 m²/gm, about 3,000-4,000 m²/gm, about 4,000-5,000 m²/gm, about 150-4000 m²/gm, about 200-1000 m²/gm, about 400-500 m²/gm, about 900-1600 m²/gm, about 1600-2500 m²/gm, or about 2500-5000 m²/gm.

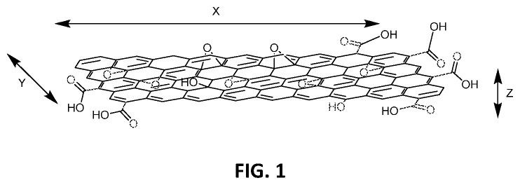

It may be desirable for the graphene oxide to have some, or all of, the platelets having one or more dimensions in the nanometer to micron range. In some embodiments, as shown in FIG. 1, the platelets may have: an average x dimension greater than 5 μm, about 0.05-100 μm, about 0.05-0.1 μm, about 0.1-0.15 μm, about 0.15-0.2 μm, about 0.2-0.4 μm, about 0.4-1.0 μm, about 1-2 μm, about 2-5 μm, about 5-10 μm, about 10-20 μm, about 20-30 μm, about 30-40 μm, about 40-50 μm, about 50-60 μm, about 40-60 μm, about 40-100 μm, or any value in a range bounded by, or between, any of these lengths; an average y dimension of 0.05-100 μm, about 0.05-0.1 μm, about 0.1-0.15 μm, about 0.15-0.2 μm, about 0.2-0.4 μm, about 0.4-1.0 μm, about 1-2 μm, about 2-5 μm, about 5-10 μm, about 10-20 μm, about 20-30 μm, about 30-40 μm, about 40-50 μm, about 40-60 μm, about 50-60 μm, about 60-100 μm, or any value in a range bounded by, or between, any of these lengths. In some embodiments, the average x and y dimensions are about 40-60 μm, e.g., about 50 μm.

In some embodiments, both x and y are greater than about 5 microns (or micrometers, μm), greater than about 10 μm, greater than about 20 μm, greater than about 25 μm, greater than about 30 μm, greater than about 40 μm, or greater than about 50 μm, about 5-20 μm, about 20-30 μm, about 30-40 μm, about 40-50 μm, about 50-60 μm, about 60-70 μm, about 70-80 μm, about 80-90 μm, about 90-100 μm, about 100-500 μm, about 40-60 μm, about 10-50 μm, about 25-50 μm, about 5-50 μm, about 30-50 μm, or about 20-60 μm.

In some embodiments, the optionally substituted graphene oxide may be unsubstituted. In some embodiments, the optionally substituted graphene oxide may comprise a non-functionalized graphene base. In some embodiments, the graphene oxide material may comprise a functionalized graphene base.

### EXAMPLE

Graphene oxide was prepared from graphite using a modified Hummers' method. Graphite flake (4.0 g, Aldrich 100 mesh) was oxidized in a mixture of NaNO₃ (4.0 g), KMnO₄ (24 g) and concentrated 98% sulfuric acid (192 mL) at 50° C. for 15 hours; then the resulting pasty mixture was poured into ice (800 g) followed by addition of 30% hydrogen peroxide (40 mL). The resulting suspension was stirred for 2 hours to reduce manganese dioxide, then filtered through filter paper and the solid washed with 500 mL of 0.16 N hydrochloric acid aqueous solution then DI water twice. The solid was collected and dispersed in DI water (2 L) by stirring for two days, then sonicated with a 10 watt probe sonicator for 2 hours with ice-water bath cooling. The resulting dispersion was centrifuged at 3000 rpm for 40 min to remove large non-exfoliated graphite oxide. The size of the GO platelets prepared in this manner was approximately 50 μm.

Unless otherwise indicated, all numbers expressing quantities of ingredients, properties such as molecular weight, reaction conditions, and etc. used in herein are to be understood as being modified in all instances by the term “about.” Each numerical parameter should at least be construed in light of the number of reported significant digits and by applying ordinary rounding techniques. Accordingly, unless indicated to the contrary, the numerical parameters may be modified according to the desired properties sought to be achieved, and should, therefore, be considered as part of the disclosure. At the very least, the examples shown herein are for illustration only, not as an attempt to limit the scope of the disclosure.

The terms “a,” “an,” “the” and similar referents used in the context of describing embodiments of the present disclosure (especially in the context of the following claims) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illustrate embodiments of the present disclosure and does not pose a limitation on the scope of any claim. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Certain embodiments are described herein, including the best mode known to the inventors for carrying out the embodiments. Of course, variations on these described embodiments will become apparent to those of ordinary skill in the art upon reading the foregoing description. The inventor expects skilled artisans to employ such variations as appropriate, and the inventors intend for the embodiments of the present disclosure to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A method for preparing graphene oxide (GO), comprising mildly sonicating a dispersion of treated GO in an aqueous solution, wherein the treated GO has been treated by a method comprising washing a crude GO solid with dilute acid solution followed by water then isolating the treated GO by filtering prior to dispersing the treated GO in the aqueous solution.

2. The method of claim 1, wherein the dilute acid solution is between about 0.01 N and about 0.5 N.

3. The method of claim 1, wherein the dilute acid solution comprises a strong acid.

4. The method of claim 3, wherein the dilute acid solution comprises hydrochloric acid.

5. The method of claim 1, wherein the crude GO solid has a weight of about 100 mg to about 100 g.

6. The method of claim 1, wherein the dilute acid solution has a volume of about 250 mL to about 1000 mL.

7. The method of claim 1, wherein the aqueous solution is deionized water.

8. The method of claim 1, wherein the dispersion is mildly sonicated at a power of about 0.001 watts/g to about 0.100 watts/g.

9. The method of claim 1, wherein the dispersion is mildly sonicated for a period of about 1 minute to about 100 hours.

10. The method of claim 1, wherein the dispersion is mildly sonicated in an ice-water bath.

11. The method of claim 1, further comprising centrifuging the dispersion at a speed of about 1000 rpm to about 5000 rpm.

12. The method of claim 11, wherein the dispersion is centrifuged for about 10 minutes to about 60 minutes.

13. The method of claim 1, wherein, after being washed with the dilute acid solution, the GO is washed with water two times before dispersion in an aqueous solution.

14. A graphene oxide dispersion prepared according to claim 1, wherein the graphene oxide dispersed in solution has an average size that is greater than about 5 μm.

15. A graphene oxide dispersion prepared according to claim 14, wherein the graphene oxide dispersed in solution has an average size that is about 50 μm.
